(19) United States
(12) Patent Application Publication
(10) Pub. No.: US 2024/0275604 A1
(43) Pub. Date: Aug. 15, 2024

(54) SYSTEM FOR ADVANCED USER AUTHENTICATED KEY MANAGEMENT FOR 6G-BASED INDUSTRIAL APPLICATIONS

(71) Applicant: HOSEO UNIVERSITY ACADEMIC COOPERATION FOUNDATION, Asan-si (KR)

(72) Inventors: Huhnkuk LIM, Daejeon (KR); Sajjad Ahmad KHAN, Asan-si (KR); Shehzad Ashraf CHAUDHRY, Abu Dhabi (AE)

(73) Assignee: HOSEO UNIVERSITY ACADEMIC COOPERATION FOUNDATION, Asan-si (KR)

(21) Appl. No.: 18/462,404

(22) Filed: Sep. 7, 2023

(30) Foreign Application Priority Data
Jan. 31, 2023 (KR) 10-2023-0013025

(51) Int. Cl. H04L 9/32; H04L 9/08

(52) U.S. Cl. CPC H04L 9/3231; H04L 9/0825; H04L 9/3236

(57) ABSTRACT

Disclosed is a system for advanced user authenticated key management for 6G-based industrial applications with respect to user authentication and management scheme to secure a 6G-enabled Network-In-a-Box (NIB). The system includes: a registration unit configured to perform registration of smart industrial device, content server, and user by using a trusted authority and an ID of the trusted authority; a user login unit configured to compute whether a Hamming distance between a biometric secret key provided to the registration unit and a currently recognized biometric secret key is equal to or less than a pre-defined error tolerance threshold; and a user authentication unit configured to perform mutual authentication among a pre-registered user Ux, a content server CSy, and an accessed smart industrial device SDz. Accordingly, a 6G-enabled Network-In-a-Box (NIB) can be secured.

### CROSS REFERENCE TO RELATED APPLICATION

The present application claims priority to Korean Patent Application No. 10-2023-0013025, filed Jan. 31, 2023, the entire contents of which is incorporated herein for all purposes by this reference.

### BACKGROUND OF THE INVENTION

### Field of the Invention

The present disclosure relates to a system for advanced user authenticated key management for 6G-based industrial applications. More particularly, the present disclosure relates to a system for advanced user authenticated key management for 6G-based industrial applications with respect to a user authentication and management scheme to secure a 6G-enabled Network-In-a-Box (NIB).

### Description of the Related Art

In a 6G mobile system, the importance of security increases even more in a communication system. One of the potential technologies of 6G is a Network-In-a-Box (NIB). The 6G-enabled NIB is a multi-generational, easily and quickly installable technology used for communication.

It is based on both hardware and software. The main features of the 6G-enabled NIB include low latency and a high level of flexibility. In addition, it provides connectivity services to the applications used in unusual situations such as battlefields or natural disasters in the industry. However, most of the applications used in the 6G-enabled NIB are not appropriately secured. There are chances of several active and passive attacks due to the insecure channel.

The 21st century is the era of modern technologies and communication, with the organization of security group (SG) frameworks. On the other hand, the sixth generation (6G) architecture is under development and expected to launch in 2030.

In 6G mobile networks, the trend toward cloud and edge native infrastructures is projected to continue and require a complete 6G network security architecture design.

A new term “Network In a Box (NIB)” is a new concept refers to a unique networking assembly that may supply essential service to its neighbors and mobile objects. The NIB is able to give customers in crisis phone, SMS, and Internet access. The main characteristics of NIB are the high resilience, robustness, and dependability of the underlying network configuration. Therefore, the NIB must be a lightweight, highly portable, mobility-aware, privacy-protecting tool. Due to the presence of latency, non-cognitive behavior, and three-dimensional connectivity, 2G, 3G, 4G, and 5G may not be efficient enough to exploit massive connection-aware network service provisioning. Hence, it provides dynamic solutions for 6G mobile network as well gained enormous popularity nowadays. This multi-generational, 6G-enabled NIB can be carried in a bag.

Hence, the 6G-enabled NIB is a collection of hardware and software elements for mobile communication that are simple to set up and maintain. The fundamental concept behind the use of NIB is to provide communication services in catastrophe scenarios such as earthquakes, industrial disasters, battlefields, floods, emergency situations, etc. In addition, the concept of NIB relies on merging all types of software and hardware modules that are required by mobile networks inside a single bag that contains a small number of physical devices. Due to its high degree of customization and increased dependability, this highly adaptable 6G-enabled NIB can provide communication services for a wide variety of applications. It is important to emphasize that emergency and tactical networks are designed to be adaptable and flexible due to the fact that their deployment is not well known. They are classified as “mobile ad-hoc networks (MANETs)” in this category. Furthermore, the NIB is a portable entity by nature. As a result, it may be used in disaster management situations especially for control in industries.

Recently, specifications for disaster and mobile networking systems have been improved to allow the systems to operate with fewer physical devices while still accomplishing the primary purpose of enhancing serviceability. Many network providers have also adopted this approach in order to build these networks. The approach may be set up with a small number of physical devices or a single device. As a result, the development of NIB is a new network communication technology that meets the requirements of future-generation mobile networks, such as the use of industrial mobile communication networks. In general, the 6G-enabled NIB may be “configured to operate alone or in combination with existing legacy network elements or NIBs”. In addition, it is designed to enable access to all wireless networks in a compact, portable device. Corporate, industrial, private, public, military, and security applications, 6G-based “evolved packet core (EPC)”, “tower with antenna”, “user with a mobile device”, “IP multimedia sub-system (IMS)”, “content server”, “smart industrial devices”, and “trusted authority (TA)” are just a few of the elements constituting the 6G-enabled NIB and can be used in industrial applications.

These components help people communicate with each other and obtain important services, such as web-based information, video streaming, or information on smart industrial equipment. To monitor and control industrial equipment, intelligent industrial tools such as a programmable logic controller (PLC), a distributed control system (DCS), and SCADA, are used. Through the 6G wireless communication technology, data can be exchanged between different components and devices.

The 6G-enabled NIB can be deployed in important conditions to provide secure communication and public safety during natural disasters. The internet providers use mobile broadband (MBB) services to access the application program server via the Internet. In the RAN architecture, mobile operators employ eNB and a collection of SGW, PGW, and MME to provide public services. Consequently, the LTE-based public service strategy might be implemented inside the 6G-enabled NIB with the appropriate adjustments to 6G-oriented service protocols.

There are several benefits of using the 6G-enabled NIB compared to previous wireless communication technologies. However, there are some network security concerns regarding the forthcoming 6G-based mobile networks (i.e., NIB).

This occurs because security measures are not completely implemented in modern mobile networks, such as 6G. According to study results, there is a newly discovered capacity for third-person attacks in terahertz 6G networks that could be exploited. It is important to stress that the 6G-enabled NIB implemented for commercial implementation have various security and privacy concerns, such as exposed to many cyber-attacks. It is possible to conduct various attacks on the 6G-enabled NIB targeting industrial applications known to have significant security implications. These attacks include replaying, third-person, cloning, unauthorized access to data, unauthorized key exchange calculation, and attacks from the stolen devices. Accordingly, it is needed to develop security rules for a “6G-enabled NIB used for industrial purposes”.

In order to access real-time data, a registered user must also be authenticated with smart industrial equipment used to receive information. For example, disaster management (earthquakes and tsunamis) is one of the important applications of NIB in which a user has to be able to receive real-time information directly from smart industrial equipment installed in the 6G-based network. To alleviate the problems, authentication and key establishment with an authorized user and accessible smart industrial equipment must occur through an important intermediate node known as the content server. The content server is positioned between two units. Thus, it is necessary to develop a new and comprehensive user authentication protocol system that allows mutual authenticated key configuration between users and intelligent industrial equipment through a content server.

The implementation of NIB and portable networks seem to be very important for the future industrial revolution. Logistics, factory-floor robots, and warehouse management may demand very dense deployment of mobile-aware and adaptable services. Such use cases must be allowed by the 6G-enabled NIB to promote low latency in order to optimize performance. In the past, disaster management lacked networking plans and failed to provide better communication. Therefore, the 6G-enabled NIB is expected to play an effective role in this regard. Furthermore, the 6G-enabled NIB enables self-healing and self-organizing networking infrastructures to ensure seamless communication between the victim and rescuer during any natural or artificial disaster. However, most of the applications used in the 6G-enabled NIB are not appropriately secured. There are chances of several active and passive attacks due to the insecure channel. An authentication scheme (UAKMS-NIB) is presented in the Wazid et al.'s article. However, there is a missing step to exchange the authentication key between the content server and smart devices. The smart device directly transmits the key to the user without information on the authentication key. Therefore, there is a problem that communication is impossible without exchanging authentication key information.

The foregoing is intended merely to aid in the understanding of the background of the present disclosure, and is not intended to mean that the present disclosure falls within the purview of the related art that is already known to those skilled in the art.

### DOCUMENT OF RELATED ART

(Patent Document 1) Korean Patent Application Publication No. 10-2021-0066733 (7 Jun. 2021)

### SUMMARY OF THE INVENTION

The present disclosure is directed to providing a system for advanced user authenticated key management for 6G-based industrial applications with respect to a user authentication and management scheme to secure a 6G-enabled Network-In-a-Box (NIB).

According to the present disclosure, there is provided a system for advanced user authenticated key management for 6G-based industrial applications, the system including: a registration unit configured to perform registration of smart industrial device, content server, and user by using a trusted authority and an ID of the trusted authority; a user login unit configured to compute whether a Hamming distance between a biometric secret key provided to the registration unit and a currently recognized biometric secret key is equal to or less than a pre-defined error tolerance threshold; and a user authentication unit configured to perform mutual authentication among a pre-registered user Ux, a content server CSy, and an accessed smart industrial device SDz.

An embodiment of the present disclosure can provide a system for advanced user authenticated key management for 6G-based industrial applications with respect to a user authentication and management scheme to secure a 6G-enabled Network-In-a-Box (NIB).

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating a network model for a 6G-enabled NIB realized for industrial applications according to the present disclosure;

FIG. 2A to FIG. 2D are diagrams illustrating a conventional method;

FIG. 3A to FIG. 3E are diagrams illustrating a proposed method according to the present disclosure; and

FIG. 4 is a block diagram illustrating a system for advanced user authenticated key management for 6G-based industrial applications according to an embodiment of the present disclosure.

### DETAILED DESCRIPTION OF THE INVENTION

Specific structures or functions described in embodiments of the present disclosure are exemplified to illustrate embodiments according to the spirit of the present disclosure, and the embodiments according to the spirit the present disclosure can be achieved in various ways. In addition, the present disclosure should not be construed as being limited to the following embodiments and should be construed as including all changes, equivalents, and replacements included in the spirit and scope of the present disclosure.

In the meantime, terms “first” and/or “second” used in the present disclosure can be used to describe various elements, but the elements are not to be construed as being limited to the terms. The terms are used to distinguish one element from another element, and for instance, a first element may be referred to as a second element, and similarly, a second element may be referred to as a first element without departing from the scope according to the spirit of the present disclosure.

A system for advanced user authenticated key management for 6G-based industrial applications according to an embodiment of the present disclosure proposes a new remote user authentication and key management technique. This scheme is a modified and improved version of UAKMS-NIB and is renamed as an improved user authentication and management scheme to secure the 6G-enabled NIB (iUAKMS-NIB) that can be used in industrial applications. Hence, the proposed method provides the best security solution against the possible attacks on the 6G communication system. As an analysis result, the proposed technique shows better performance than the existing techniques.

In order to counter the incorrectness mentioned above, the present disclosure proposes an improved method based on an elliptic curve, which provides user authentication and better security.

The present disclosure proposes an advanced user authentication and management scheme for secure communication in the 6G-enabled NIB (iUAKMS-NIB). The proposed method verifies an authentication process between a user and a smart industrial device through a verification key.

The present disclosure provides various analyses to ensure security and verify authentication between a user and a smart industrial device. An experiment is conducted by using Raspberry-Pi, iphone Xs Max, and Dell Ultrabook 8757P. It is demonstrated that the iUAKMS-NIB is resilient to various possible attacks required in a 6G-enabled NIB environment.

Testbed studies on different authenticated key methods are conducted using Burrows Abadi and Needham Logic (BAN Logic) widely used in both the server and user environments, and the results are presented.

Finally, a comparative analysis of computation and communication costs is presented and discussed. The results show that the improved iUAKMS-NIB method verifies authentication and exchanges a verified key between a user and a smart industrial device through the content server during user authentication.

The proposed method, that is, iUAKMS-NIB, will be described using the following two models.

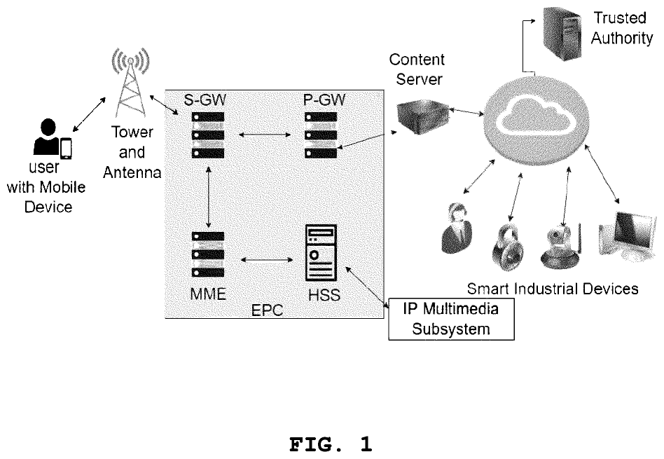

The overall network model is as shown in FIG. 1.

FIG. 1 is a diagram illustrating the network model for the “6G-enabled NIB” implemented for industrial applications. The NIB provides connections and enables various types of entities to communicate with each other. The NIB is used to provide integrated voice and data services via mobile communication networks, such as 3G and 4G, and beyond mobile networks. The EPC incorporates important elements such as the Packet Data Network Gateway (P-GW), the Serving Gateway (S-GW), the Mobility Management Entity (MME), and the Home Subscriber Server (HSS). The mobile device serves as a connection point between external networks. The mobile device serves as the point of entry for data flow for the user. The user's mobile device may be linked to several P-GWs simultaneously to access the P-GWs. In addition, the S-GW is responsible for routing and forwarding of user data packets. The S-GW is also in charge of inter-eNB handovers and the provision of mobility between long-term evolution (LTE) and other types of networks (e.g., between 2G/3G and P-GW). An eNB is a type of base station that is responsible for controlling mobile phones in a group of cells. A serving eNB is the base station that connects with a user mobile device. “Idle mode user mobile device tracking”, “paging procedure (that is, re-transmission)”, “bearer activation and deactivation process”, “S-GW selection for a user mobile device at the initial attach”, “intra-handover with the core network”, and “user mobile device authentication with HSS” are just a few of the tasks that the MME is responsible for in the NIB.

The MME server also manages encryption and integrity projection for non-access stratum (NAS) signals, as well as security key management. The HSS is also an important element of the NIB system. The HSS is a master user database (that is, device) only kept on a single node in a cluster. Communications service providers may manage consumers in real time and at a reasonable cost as a result of this technology.

Information on subscribers (that is, users) is stored in the HSS database in order to assist with authorization as well as user location and other associated service information and specifications for devices.

In addition, connection between a user's request and the IP Multimedia Subsystem (IMS) is set. In an integrated network of communications service providers, an IMS provides telephony, fax, e-mail, Internet access, web services, and voice over IP (VOIP) in wired or wireless communication.

The content server, which serves as a link between a user and a smart industrial device, is also an essential node in the network.

A smart industrial device network has been built on this network to monitor and control industrial machinery. Each intelligent industrial device has a particular goal to achieve. Users of an industrial facility may sometimes be interested in gaining access to real-time data collected by smart industrial equipment. Users and smart industrial devices must go through authentication and key setting methods to share information in a secure manner with each other.

A scheme named UAKMS-NIB in the present disclosure will be described. Several phases used in a UAKMS-NIB method will be described in detail.

### A. Registration Phase

This phase is executed by a TA and for the TA selects an elliptic curve Eₚ(xₓ,x_{y}): y²=x³+xₓ+x_{y}(modp) and a base point P over GF(p). Next, the TA selects a one-way hash function h(⋅).

### 1) Registration of Smart Industrial Device

The TA registers a smart industrial device (SDz) through execution of the following steps.
RD-1: The TA selects its own secret key d_{TA} and the ID, secret key, and public key tuple {ID_{z},d_{z},Q_{z}=d_{z}·P} for the SDz along with ID RD_{z}=h(ID_{z}∥d_{TA}). Next, the TA uses the timestamp RTS_{z} to compute TC_{z}=h(d_{z}∥ID_{z}∥RTS_{z}∥d_{TA}).
RD-2: The information, such as RD_{z}, TC_{z}, Q_{z}, d_{z}, h(⋅), Eₚ (a,b), and P, obtained from RD-1 is stored in the memory of the SD_{z}. It is noted that the Q_{z} is announced widely to the other entities. In addition, the RD_{z} may be transmitted to the CSy through the TA in a secure method.

### 2) Registration of Content Server

The content server is registered in this phase. This task is executed by the TA in the following steps.
RCS-1: In order to calculate the ID of the CSy as RD_{y}=h(ID_{y}∥d_{TA}), public key Q_{y}=d_{y}·P, the TA selects a unique ID ID_{CSj} and a random secret key d_{y} for the CS_{y}. In the meantime, the TA also generates its own ID RD_{TA}=h(ID_{TA}∥d_{TA}) random identity.
RCS-2: The related content server and user information Rd_{y}, RDₓ, TIDₓ, RD_{TA}, RDₓ, Q_{y}, d_{y}, h(⋅), Eₚ(a,b), and P is stored on a database created in a temperature-resistant memory of the TA. Herein, in {RDₓ, TIDₓ}, a user-related parameter (Uₓ) is registered. The public key Q_{y} of the content server is publicly available to all intended entities.

TABLE 1

| Symbol | Explanation |
|---|---|
| A | An adversary |
| Uₓ, Dₓ | x^{th} use and his/her mobile device, respectively |
| IDₓ, RDₓ | x's identity and pseudo identity, respectively |
| PW′ₓ, BOₓ | x's password and biometric, respectively |
| TA, ID_{TA} | Trusted authority and its identity, respectively |
| RD_{TA} | TA's pseudo identity |
| CS_{y}, ID_{y} | y^{th} content server and its identity, respectively |
| RD_{y} | Pseudo identity of CS_{y} |
| SD_{z}, ID_{z} | y^{th} smart industrial device & its identity, respectively |
| RD_{z} | Pseudo identity of SD_{z} |
| dₓ, d_{y} | 160-bit secret keys of Uₓ and CS_{y} respectively |
| d [symbol] d_{TA} | Secret keys of SD_{z} and TA, respectively |
| X | 1024-bit long-term random secret of Uₓ |
| rₓ, r_{y} | 160-bit random secrets of Uₓ and CS_{y}, respectively |
| r_{z} | 160-bit random secret of SD_{z} |
| T [symbol] | Various current timestamps |
| ΔT | Maximum transmission delay |
| Gen(•) | Generation process in fuzzy extractor |
| Rep(•) | Reproduction process in fuzzy extractor |
| α′ₓ | Biometric secret key of Uₓ for BO [symbol] |
| [symbol] ₓ | Public reproduction parameter of Uₓ for BOₓ |
| t | Error tolerance threshold required by fuzzy extractor |
| h(•) | Collision-resistant cryptographic one-way hash function |
| SKₓ, SDₓ | Session key between Uₓ and SDₓ |
| ∥, ⊕ | Concatenation & bitwise XOR operations, respectively |
| d [symbol] | Private key of entity E |
| Q [symbol] | Public key of entity E, where Q [symbol] = d [symbol] P, |
| | where P is an elliptic curve point. |

[symbol]

indicates data missing or illegible when filed

Table 1 shows symbols and notation used in the iUAKMS-NIB.

### 3) User Registration

This phase provides user registration. To perform this phase, a user Uₓ interested in registering and the TA communicate with each other over a secure channel through execution of the following steps.
RU-1: The Uₓ selects an ID-password pair {IDₓ, PWₓ′} in addition to a secret and random long-term key x∈Zₚ*, and then computes RPWₓ′=h(PWₓ∥x). Then, the Uₓ transmits {IDₓ,RPWₓ′} to the TA.
RU-2: When receiving {IDₓ,RPWₓ′}, the TA computes ID {RDₓ=h(IDₓ∥d_{TA}), TIDₓ} and a temporary ID dₓ∈Zₚ*, in addition to a secret and random key. Next, the TA computes a public key for the Uₓ and a temporary parameter Qₓ=dₓ·P. The TA computes temporal credential of the Uₓ as TCₓ=h(IDₓ∥RPWₓ″∥dₓ∥d_{TA}∥RTSₓ) and αₓ′=h(RPWₓ′∥RDₓ)⊕dₓ (also referred to as temporal credential) for the Uₓ. The TA transmits the tuple including {RDₓ, TIDₓ, RD_{TA}, TCₓ, αₓ′, Qₓ, h(⋅), Eₚ(a,b), P} to the Uₓ.

The TA places Qₓ over a public space and any intended identity has access to the Qₓ.
RU-3: When receiving {RDₓ, TIDₓ, RD_{TA}, TCₓ, αₓ′, Qₓ, h(⋅), Eₚ(a,b), P}, the Uₓ pins BOₓ and Dₓ computes (αₓ′, τₓ)=GenB(BOₓ). Herein, BOₓ, αₓ′, and τₓ are the Uₓ's biometric information, a BOₓ related secret key, and a re-production parameter, respectively. In addition, GenB(⋅)/RepB(⋅) are generation and re-production functions of the fuzzy-extractor related to biometrics. Then, the Uₓ further computes the following.

$${d}_{x} = h ( {RPW}_{x}^{′} ‖ {RD}_{x} ) ⊕ {α}_{{U}_{x}}^{′} ,$$

$${TC}_{x} = h ( {TC}_{x} ‖ x ‖ {α}_{x}^{′} ) , {x}^{*} = x ⊕ h ( {ID}_{x} ‖ {PW}_{x}^{′} {α}_{x}^{′} ) ,$$

$${RD}_{x}^{*} = {RD}_{x} ⊕ h ( {PW}_{x}^{′} ‖ {α}_{x}^{′} ) ,$$

$${TID}_{x}^{*} = {TID}_{x} ⊕ h ( {ID}_{x} ‖ {PW}_{x}^{′} ) ,$$

$${RD}_{TA}^{*} = {RD}_{TA} ⊕ h ( {ID}_{x} ‖ {RPW}_{x}^{′} ‖ {α}_{x}^{′} ) ,$$

$${TC}_{x}^{*} = {TC}_{x} ⊕ h ( {ID}_{x} ‖ {RPW}_{x}^{′} ‖ {α}_{x}^{′} ) , {d}_{x}^{*} = {d}_{x} ⊕ h ( {ID}_{x} ‖ {α}_{x}^{′} )$$

$$LV = h ( {ID}_{x} ‖ {RPW}_{x}^{′} ‖ {TC}_{x} ‖ {d}_{x} ‖ {α}_{x}^{′} ) .$$

The Uₓ updates Dₓ with the tuple RIDₓ*, TIDₓ*, RD_{TA}*, TCₓ*, dₓ*, Qₓ, τₓ, LVₓ*, h(⋅), Gen(⋅), Rep(⋅), t, Eₚ(a,b).
RU-4: The TA on successful registration of the user Uₓ transmits RDₓ, TIDₓ to the CS_{y} and removes the tuple RDₓ, TIDₓ, RD_{y}, RD_{z}, dₓ, d_{y}, d_{z}, TCₓ, TC_{z}, αₓ, RPWₓ′ from the TA's own memory.

### B. User Login and Authentication Phase

A registered user Uₓ initiates this phase to obtain NIB services, and for this, the Uₓ performs the following login and authentication steps.
ULA-1: The Uₓ submits the tuple {IDₓ, PWₓ′, BOₓ′} consisting of its ID, password, and biometric information. The Dₓ checks the relation of BO′ₓ with the user biometric information imprinted during the registration phase, and the Dₓ is checked when two pieces of biometric information match. The user side computes Dₓ. The Dₓ confirms the authenticity of the Uₓ if LV holds, and furthers the process by generating the timestamp and random number pair T1. The user device computes M1 and selects the smart device with RD_{z} as a pseudo ID. The Uₓ completes this step by transmitting Msg1 D to the CS_{y} via an open channel.

The following is the details of ULA-1.

The Uₓ submits the tuple {IDₓ, PWₓ′, BOₓ′} consisting of its ID, password, and biometric information. The Dₓ checks the relation of BOₓ′ with the user biometric information imprinted during the registration phase, and when two pieces of biometric information match, the Dₓ computes d′x=RepB(BO′x, τₓ).

The user side computes the following.

$$x = x ⊕ h ( IDx ‖ {PW}^{′} x {a}^{′} x ) ,$$

$${RPW}^{′} x = h ( {PW}^{′} x ‖ x ) ,$$

$$RDx = RDx ⊕ h ( {PW}^{′} x ‖ {a}^{′} x ) ,$$

$$TIDx = TIDx ⊕ h ( IDx ‖ {PW}^{′} x ) ,$$

$$RDTA = RDTA ⊕ h ( IDx ‖ {RPW}^{′} x ‖ {a}^{′} x ) ,$$

$$TCx = TCx ⊕ h ( IDx ‖ {RPW}^{′} x ‖ {a}^{′} x ) ,$$

and a′dx=dx⊕h(IDₓ∥a′x).

The Dx confirms the authenticity of the Ux if LV=h(IDx)∥RPW′x∥TCx∥dx∥a′x), and furthers the process by generating the timestamp and random number pair {T1, rx}.

The user device computes M1=h(rx∥T1)⊕(RDTA∥RDx∥dx·Qy∥T1), MM1=h(h(rx∥T1)∥TCx∥T1∥RDx∥RDTA)⊕h(h(rx∥T1)∥RDTA∥T1), Mx=h(RDx)∥RDTA), M2=Mx·P, M3=Mx+h(rx∥T1)·dx and selects the smart device with RDz as a pseudo ID. The Ux completes this step by transmitting Msg1={TIDx, RDz, M1, MM1, M2, M3, T1} to the CSy via an open channel.

The following is the details of ULA-2.
ULA-2: After successful login and receiving of Msg1={TIDx, RDz, M1, MM1, M2, M3, T1g}, the CSy checks the timestamp (T1) freshness and extracts RDx related to the received TIDx. Next, the CSy computes h(rx∥T1)=M1⊕h(RDTA∥RDx∥dy·Qx∥T1) and Mx=h(RDx∥RDTA). If M3 P=M2+h(rx∥T1)·Qx, the CSy confirms the genuineness of the Ux. After confirming genuineness, the CSy generates the timestamp and random number pair {T2, ry} and computes M4=h(ry∥T2∥RDy)⊕h(RDz∥dy·Qz∥T2), MM2=MM1⊕h(h(rx∥T1)∥RDTA∥T1)⊕h(h(ry∥T2∥RDy)∥T2∥RDz), My=h(RDz∥T2), M5=Mz·P, and M6=My+h(ry∥T2∥RDy)·dy. Next, the CSy generates TIDₓ^{new} and computes MT=TIDₓ^{new}⊕h(h(rx∥T1)∥RDTA∥T2). Herein, TIDₓ^{new} is a new temporary ID for the Ux.

The CSy transmits Msg2={RDz, M4, MM2, M5, M6, MT, T1, T2} to the SDz.

The following is the details of ULA-3.
ULA-3: When receiving Msg2={RDz, M4, MM2, M5, M6, MT, T1, T2}, the timestamp (T2) freshness is checked, and the SDz computes h(ry∥T2∥RDy)=M4⊕h(RDz∥dz·Qy∥T2), h(h(rx∥T1)∥TCx∥T1∥RDx∥RDTA)=MM2⊕h(h(rx∥T1)∥RDTA∥T1)⊕h(h(rx∥T1)∥RDTA∥T1)(+)h(h(ry∥T2∥RDy)∥T2∥RDz), My=h(RDz∥T2) and checks M6·P=M5+h(ry∥T2∥RDy)·Qy.

When the previous condition holds, the SDz further computes Xs=h(h(rx∥T1)∥TCx∥T1∥RDx∥RDTA). The SDz further the process by generating the timestamp and random number pair {T3, rz}, and computes M7=h(rz∥T3)⊕h(T1∥T3∥dz·Qx), Mx=h(RDz∥TCz)⊕h(h(rz∥T3)∥T1), Mz=h(h(RDz∥TCz)∥T1∥T3), M8=Mz·P and session key SKSDz, Ux=h(Xs∥h(rz∥T3)∥T1∥T2∥T3∥Mz).

The SD_{z} generates a signature M9=Mz+h(SKz, Ux∥MT∥T1∥T3)·dz and transmits Msg3={M7, Mx, M8, M9, MT, T3, T2} to the Uₓ.
ULA-4: When receiving Msg3={M7, Mx, M8, M9, MT, T3, T2}, the Ux confirms the timestamp (T3) freshness and computes h(rz∥T3)=M7 h(T1∥T3∥Qz·dx), h(RDz∥TCz)=Mx⊕h(h(rz∥T3)∥T1), Mz=h(h(RDz∥TCz)∥T1∥T3) and session key SKUx, SDz=h(h(h(rx∥T1)∥TCx∥T1∥RDx∥RDTA)∥h(rz∥T3)∥T1∥T2∥T3∥Mz).

The Ux verifies the equality M9·P=M8+h(SKUx, SDz∥MT∥T1∥T3)·Qz, and after successful verification, the Ux computes TIDₓ^{new}=MT⊕h(h(rx∥T1)∥RDTA∥T2) and replaces TIDx with TIDₓ^{new}.

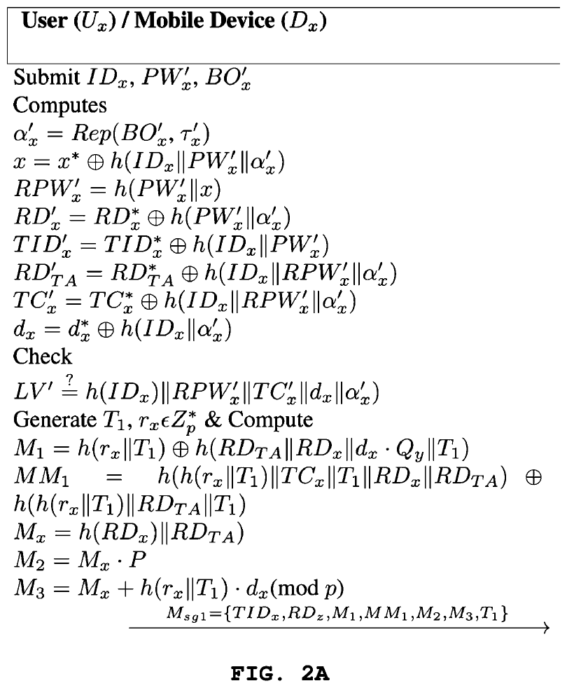

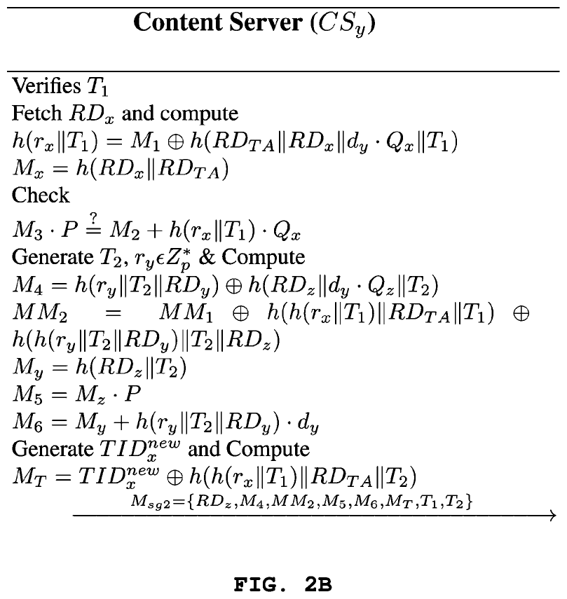

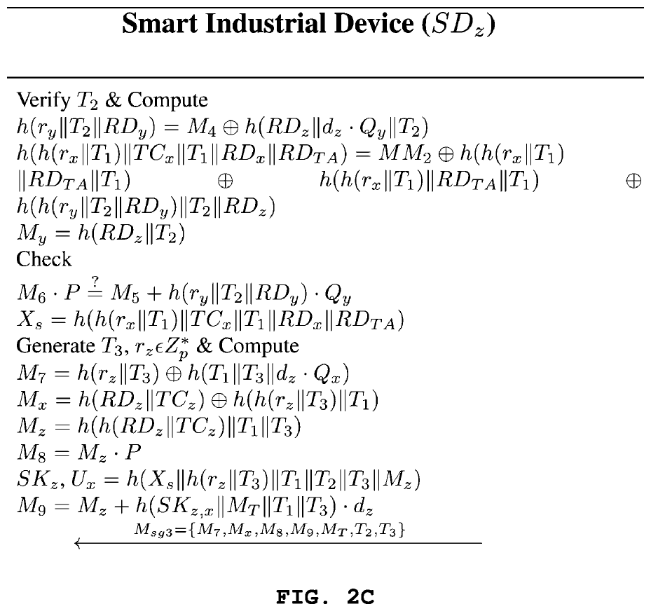

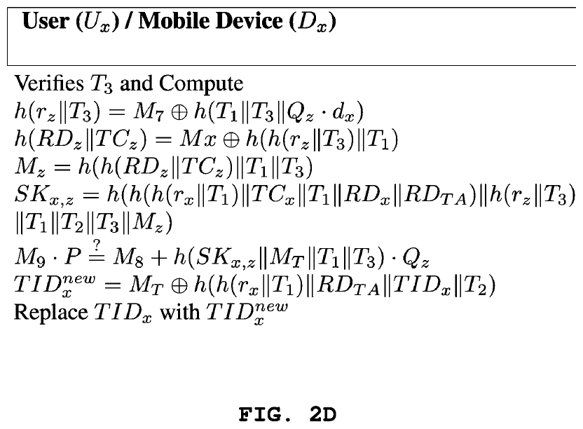

Referring to the Wazid et al.'s method shown in FIG. 2A to FIG. 2D, it is shown that the Wazid et al.'s method in FIG. 2A to FIG. 2D cannot provide authentication between a user and a smart device. It is also shown that the method entails ID synchronization issues.

The incorrectness in relation to FIG. 2A to FIG. 2D will be described as follows.

The authentication phase of the Wazid et al.'s method is incorrect and cannot be completed. As a severe consequence, a user and a smart industrial device may not share a key at all. Precisely, a user initiates a request by computing Msg1={TIDx, RDz, M1, MM1, M2, M3, T1} and transmitting the same to the CSy and the CSy further processes the request, verifies the legitimacy of the user, and then says the Ux. The message Msg2={RDz, M4, MM2, M5, M6, MT, T1, T2} is transmitted to the SDz. The SDz processes the message and verifies the legitimacy of the CSy. Next, the SDz computes Msg3={M7, Mx, M8, M9, MT, T3, T2} and transmits the same to the Ux. In this whole process, the SDz does not verify the legitimacy of the user Ux and the SDz does not know the real or pseudo ID of the user Ux, and the message Msg2 received from the CSy does not contain any tangible information on the ID of the Ux. Therefore, the step to send Msg3 from the SDz to the Ux is out of question. Thus, the scheme Wazid et al. is incorrect and due to this incorrectness, the scheme fails to complete a round of authentication process.

In addition, regarding ID de-synchronization shown in FIG. 2A to FIG. 2D, the provision of anonymity and user privacy in the Wazid et al. scheme is achieved through a temporary ID generated by the CSy during the registration phase. The temporary ID is updated during each login and authentication round as follows. The user Ux transmits a temporary ID TIDx as part of message Msg1. Upon reception of Msg1, the CSy extracts RDx corresponding to the TIDx, processes the message, generates a new temporary ID TIDₓ^{new}, and transmits MT=TIDₓ^{new} h(h(rx∥T1)∥RDTA∥T2) in which the ID is hidden. This is transmitted to the SDz with other parameters included in Msg2. The MT is transmitted from the SDz to the Ux through Msg3. Finally, after processing the message, the Ux updates the TIDx with TIDₓ^{new}.

If any of the message Msg2 or Msg3 is blocked by an attacker controlling the public communication channel as per CK attack model adopted herein, the Ux is unable to update the temporary TIDx, but the CSy has already updated the TIDx with TIDₓ^{new} after receiving Msg1. Both entities Ux and CSy have mismatched IDs. Therefore, ID de-synchronization occurs, and the next login by the Ux fails.

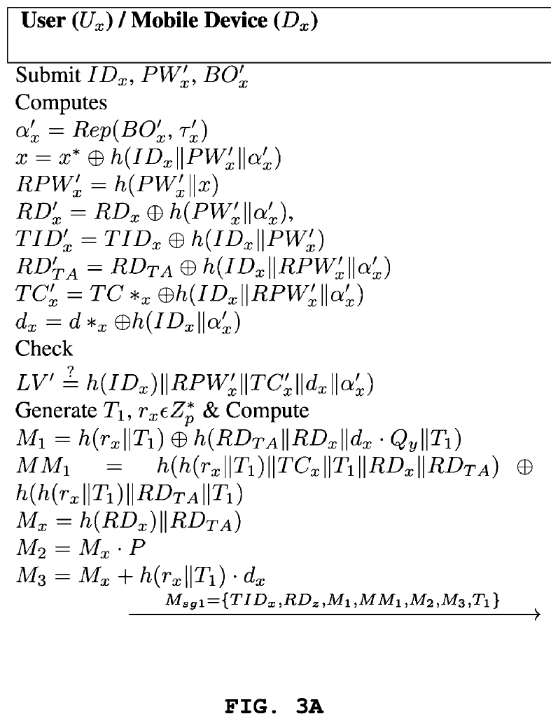

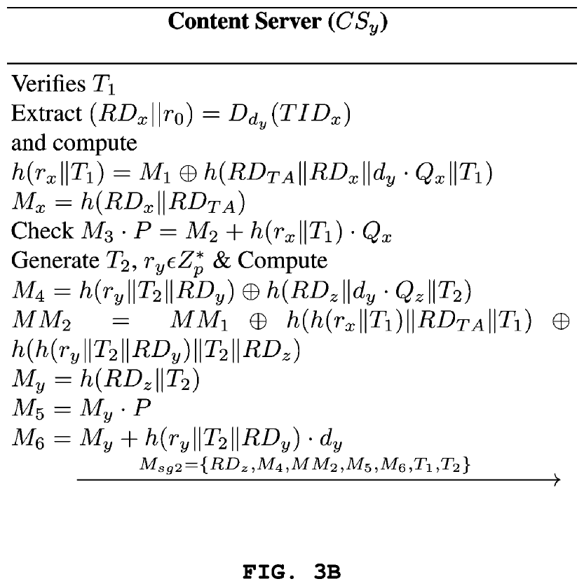

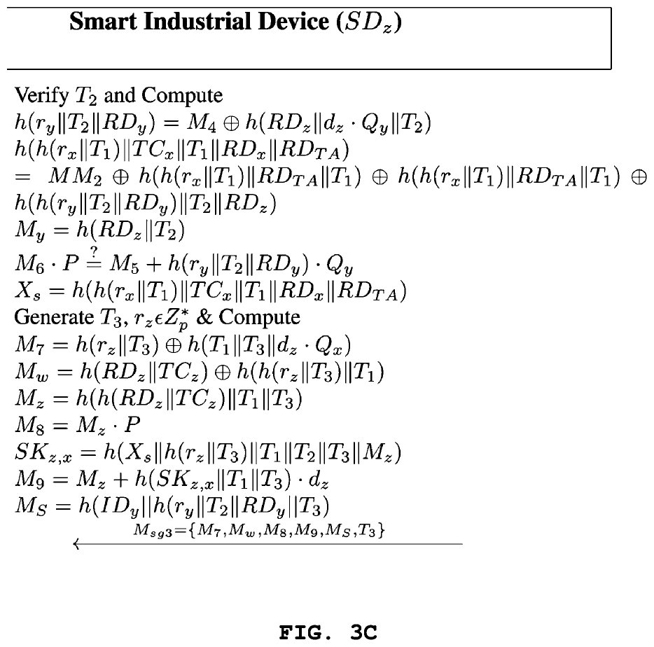

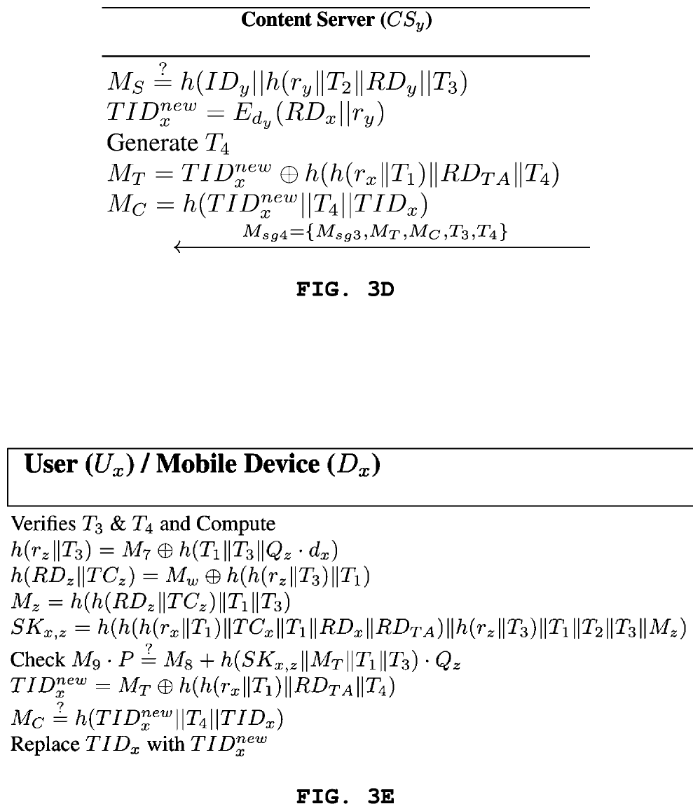

The present disclosure describes the details of an improved iUAKMS-NIB method proposed as shown in FIG. 3A to FIG. 3E.

FIG. 3A to FIG. 3E are diagrams illustrating an iUAKMS-NIB method according to an embodiment of the present disclosure.

An embodiment proposed in the present disclosure is described as follows.

### A. Registration Phase

This phase uses a fully TA (trusted authority and its identity, respectively) that selects a “non-singular elliptic curve Ep(a,b)” and forms “y2=x3+ax+b(mod p)” over a Galois (finite) field GF(p). Herein, p is a large prime such that the “Elliptic Curve Discrete Logarithm Problem (ECDLP)” is intractable with “a base point P in Ep(a, b)” of which the order is as big as p.

Furthermore, the TA selects a collision-resistant one-way cryptographic hash function h(⋅) with a private key d_{TA} of the trusted authority.

### 1) Registration of Smart Industrial Device

The TA performs the following steps for registration of the deployment of a smart industrial device. To perform this, PRS-1 and PRS-2 are included.
PRS-1: First of all, a unique ID IDz and a random secret key dz Z*p for a smart device SDz are selected by the TA. For the SDz, the TA calculates the pseudo ID of the SDz as RDz=h(IDz∥dTA), the public key of the dz as Qz=dz·P, and the temporary credential as TCz=h(dz∥IDz∥RTSz∥dTA). Herein, RTSz is the registration timestamp of SDz.
PRS-2: The information, such as RDz, TCz, Qz, dz, h(⋅), Ep(a,b), P, obtained from RSD-1 is stored in the memory of the SDz before the development of SDz. It is noted that the Qz is announced widely to the other network entities.

In addition, the RI dz may be transmitted to the CSy by the TA in a secure way.

### 2) Registration of Content Server

The content server CSy is registered in this phase. This task is executed by the TA in the following steps. To perform this, PRC-1 and PRC-2 are included.
PRC-1: The TA selects a unique ID IDy and a secret key dy=h(IDy∥dTA) for the CSy to compute the pseudo ID of the CSy as RDy-h(IDy∥dTA), a public key Qy=dy·P, and its own pseudo-random ID RDTA=h(IDTA∥dTA).
PRC-2: The credentials RDy, RDx, TIDx, RDTA, RDz, Qy, dy, h(*), Ep(a,b), P are stored for the CSy in a secure/tamper-resistant database by the TA.

The RDx and TIDx related to a registered user Ux are generated in the user registration phase as described below. In addition, the Qy is published publicly to other network entities.

### 3) User Registration

In this phase, the registration of a user Ux is performed by the TA through a secure channel (e.g., in person) using the following steps.

To perform this, PRU-1 to PRU-4 are included.
PRU-1: the Ux selects a user unique ID IDx, a password PW′x, and a long-term random password x∈Zₚ⁺ to calculate a masked password RPW′x=h(PW′x∥x). Next, the Ux transmits IDx and RPW′x to the TA through a secure channel.
PRU-2: After receiving the registration information, the TA computes a pseudo ID RDx=h(IDx∥dTA), generates a temporary ID TIDₓ=Edy(RDx∥r0) (r0 is a random number generated by the TA), computes a secret key dx=h(IDx∥dTA) for the Ux, and computes a temporary credential of the Ux as TCx=h(IDx∥RPW′x∥dx∥dTA∥RTSx), a′x=h(RPW′x∥RDx)⊕dx and a public key as Qx=dx·P. Then, the TA transmits RDx, TIDx, RDTA, TCx, a′x, Qx, h(⋅), Ep(a,b), P to the Dx of the Ux through a secure channel.

The Qx is published publicly to other network entities.
PRU-3: After receiving the information from the TA, the Ux furnishes biometric data BOX to a biometric sensor of the mobile device Dx of the Ux to compute (a′x, tx)=Gen (BOx). Herein, a′x and x are the biometric secret key of 1 bits and a public reproduction parameter, respectively and “Gen (⋅)=Rep (⋅) are the fuzzy extractor probabilistic generation and deterministic reproduction functions, respectively”. Furthermore, the Ux computes dx=h(RPW′x∥RDx)⊕a′Ux, TCx=h(TCx∥x∥a′x), x*=X⊕h(IDx∥PW′xa′x), RD*x=RDX⊕h(PW′x∥a′x), TID*X=TIDx⊕h(IDx∥PW′x), RD*TA=RDTA⊕h(IDx∥RPW′x∥a′x), TC*x=TCx⊕h(IDx∥RPW′x∥a′x, d*x=dx⊕h(IDx∥a′x), and LV=h(IDx∥RPW′x∥TCx∥dx∥a′x).

Finally, RID*x, TID*x, RD*TA, TC*x, d*x, Qx, t x, LVx*, h(⋅), Gen(⋅), Rep(⋅), t, Ep(a,b), P are stored in the memory of the Dx. a′x, x, IDx, RPW′x, RDx, TIDx, RDTA, TCx, TCx, and dx are deleted from the memory of the Dx to protect against stolen verifier, privileged insider attack, unauthorized session key computation, illegal user's password guessing, and user impersonation attacks.
PRU-4: The TA transmits the credentials RDx, TIDx to the CSy in a secure way through a pre-shared symmetric secret key Ky, TA. The TA also deletes RDx, TIDx, RDy, RDz, dx, dy, dz, TCx, TCz, a′x, RPW′x from the memory to protect against stolen verifier, privileged insider attack, unauthorized session key computation, illegal user's password guessing and user impersonation attacks.

### B. User Login Phase

To access the services of the NIB, a legitimate user Uₓ needs to first login into the system. For such propose, the following steps are required. To perform such login, PLU-1 to PLU-3 are included.
PLU-1: The Uₓ furnishes the identity IDₓ and the password PW′x of the Uₓ, and imprints the biometric BO′x at the sensor of the mobile device Dₓ of the Uₓ to calculate a biometric secret key a′x=Rep (BO′x, tx) when the Hamming distance between the real biometric Box provided during the user registration phase and the current BO′x is equal to or less than a pre-defined error tolerance threshold.
PLU-2: The Ux computes a′x=Rep (BO′x, t′x), x=x*⊕h(IDx∥PW′x∥a′x), RPW′x=h(PW′x∥x), RD′x=RDx⊕h(PW′x∥a′x), TID′x=TIDx⊕h(IDx∥PW′x), RD′TA=RDTA⊕h(IDx∥RPW′x∥a′x), TC′x=TC*x⊕h(IDx∥RPW′x∥a′x), dₓ=dₓ*⊕h(IDₓ∥αₓ′) and checks the setting condition LV′=h(IDx)∥RPW′x∥TC′x∥dx∥a′x). When the condition holds, the Ux is a genuine user. Otherwise, the login phase is halted immediately.
PLU-3: The Dₓ generates a current timestamp T1 and a random secret password rₓ∈Zₚ* to calculate M1=h(rx∥T1)⊕h(RDTA∥RDx∥dx (⋅) Qy∥T1), MM1=h(h(rx∥T1)∥TCx∥T1∥RDx∥RDTA)⊕h(h(rx∥T1)∥RDTA∥T1), Mx=h(RDx)∥RDTA), M2=Mx·P, M3=Mx+h(rx∥T1)·dx.

Next, the Ux selects an accessed smart device SDz with a pseudo ID RDz and transmits a login message Msg1={TIDx, RDz, M1, MM1, M2, M3, T1} to the CSy via an open channel.

### C. User Authentication and Key Agreement Phase

This phase is required for mutual authentication among a registered user Ux, a content server CSy, and an accessed smart industrial device SDz. After the successful completion of the following steps, both the Ux and the SDz establish a session key for secure communication via the CSy. To perform these functions, PKM-1 to PKM-6 are included.
PKM-1: After receiving Msg1 from the Ux, the CSy first verifies the timeliness of T₁ through the condition, |T₁−T₁*|≤ΔT. Herein, the “maximum transmission delay” is represented by ΔT and T₁* is the reception time of the message Msg1. If it matches, the CSy extracts (RDx∥r0)=Ddy(TIDx). The CSy further calculates h(rx∥T1)=M1⊕h(RDTA∥RDx∥dy(⋅)Qx∥T1), Mx=h(RDx∥RDTA) and checks if M3·P=M2+h(rx∥T1)·Qx. If the CSy finds this condition true, the Ux is authenticated by the CSy.
PKM-2: The CSy generates a current timestamp T2 and a random secret password rₓ∈Zₚ* to calculate M4=h(rykT2kRDy)⊕h(RDz∥dy·Qz∥T2), MM2=MM1⊕h(h(rx∥T1)∥RDTA∥T1) h(h(ry∥T2∥RDy)∥T2∥RDz), My=h(RDz∥T2), M5=My·P, and the ElGamal type signature M6=My+h(ry∥T2∥RDy)·dy. Next, the CSy transmits a message Msg2={RDz, M4, MM2, M5, M6, T1, T2} to the SDz via an open channel.
PKM-3: After receiving Msg2 from the CSy, the SDz first verifies the timeliness of T2 by checking |T₂−T₂*|≤ΔT. Herein, T₂* is the reception time of the message Msg2.

It is valid, the SDz computes h(ry∥T2∥RDy)=M4⊕h(RDz∥dz·Qy∥T2), h(h(rx∥T1)∥TCx∥T1∥RDx∥RDTA)=MM2⊕h(h(rx∥T1)∥RDTA∥T1)⊕h(h(rx∥T1)∥RDTA∥T1)⊕h(h(ry∥T2∥RDy)∥T2∥RDz), My=h(RDz∥T2), and checks M6·P=M5+h(ry∥T2∥RDy)·Qy. If the SDz finds this condition true, the CSy is authenticated by the SDz and the SDz sets Xs=h(h(rx∥T1)∥TCx∥T1∥RDx∥RDTA).
PKM-4: The SDz calculates M7=h(rz∥T3)⊕h(T1∥T3∥dz·Qx), Mw=h(RDz∥TCz)(+)h(h(rz∥T3)∥T1), Mz=h(h(RDz∥TCz)∥T1∥T3), M8=Mz·P, a session key SKz,x=h(Xs∥h(rz∥T3)∥T1∥T2∥T3∥Mz), and the ElGamal type signature M9=Mz+h(SKz, x∥T1∥T3)·dz. The, the SDz computes MS=h(IDy∥h(ry∥T2∥RDy∥T3) and transmits a message MS=h(IDy∥h(ry∥T2∥RDy∥T3) to the Ux through an open channel.
PKM-5: After receiving Msg3 from the SDz, the CSy first verifies the timeliness of T3 by checking |T₃−T₃|≤ΔT, that is, T₃*. Herein, T₃* is the reception time of the message Msg3. If it is valid, the CSy further checks MS=h(IDy∥h(ry∥T2∥RDy∥T3) and upon verification the CSy computes new pseudo ID and temporary ID TIDₓ^{new}=Edy(RDx∥ry). Next, the CSy generate a current T4 to compute MT=TIDₓ^{new}⊕h(h(rx∥T1)∥RDTA∥T4), MC=h(TIDxnewx∥T4∥TIDx) and transmits a message Msg4={MT, MC, T3, T4} to the Ux.
PKM-6: After receiving Msg4 from the CSy and after successful verification of the timeliness of T4, the Ux computes h(rz∥T3)=M7⊕h(T1∥T3∥Qz·dx), h(RDz∥TCz)=Mw⊕h(h(rz∥T3)∥T1), Mz=h(h(RDz∥TCz)∥T1∥T3), and a session key SKx, Z=h(h(h(rx∥T1)∥TCx∥T1∥RDx∥RDTA)∥h(rz∥T3)∥T1∥T2∥T3∥Mz), and checks M9·P=M8+h(SKx,z∥MT∥T1∥T3)·Qz. If the condition is true, the SDz is genuine. Otherwise, the Ux aborts the process immediately. The Ux also computes TIDₓ^{new}=MT⊕h(h(rx∥T1)∥RDTA∥T4) and checks MC=h(TIDₓ^{new}∥T4∥TIDx).

In addition, if the above condition is true, the Ux replaces TIDx with TIDₓ^{new} in the memory database to be used in the upcoming sessions.

Performance analysis according to the present disclosure will be described as follows.

The present disclosure evaluates the performance of the proposed technique in terms of computation cost and communication cost of the proposed technique with the existing techniques.

### A. Computational Cost Analysis

The present disclosure set a real-time environment in which an experiment was conducted using the MIRACL Library on a smartphone, iphone Xs Max, which has 8 GB of RAM and a Dual Core+1.6 GHZ Quad-Core Processor. The underlying IOS operating system version is version 15.1. That is, iphone Xs Max was used and represented a user/mobile device in this experiment.

The Dell Ultrabook 8757P with an Intel Core i5-6300C processor and 8 GB of RAM was used as a content server, with the Windows 10 Pro operating system running on top of the system. In a similar way, Raspberry Pi 3 BC with Cortex-A53 (ARMv8) 64-bit SoC running at 1.4 GHZ and 1 GB of LPDDR2 SDRAM RAM was used to simulate a smart device. Table 2 contains the simulation results for each device. In addition, Tf≈Te is considered. Herein, Tf is the running time of executing a fuzzy extractor and Te is the time used to compute the results. According to the experimental results, the proposed technique may complete the authentication process in about 59.00 milliseconds at a cost of 40 Th+16Te+3Ta+3Tr.

The existing methods Wazid et al., Hussain et al., Jia et al., Chang et al., and Challa et al., complete authentication processes in about 60.428, 32.929, 58.561, 14.339, and 12.574 milliseconds, respectively. According to the computational cost, the Challa et al. performs the best, but the proposed method according to the present disclosure is significantly more secure than the rest of the methods. The comparison for each entity is shown in Table 3.

TABLE 2

Device→

| ↓Operation | Mobile | Server | Drone |
|---|---|---|---|
| T [symbol] : Bi-linear Pairing | 17.36 | 4.038 | 12.52 |
| T [symbol] : Point Multiplication | 5.116 | 0.926 | 4.107 |
| T [symbol] : Point Addition | 0.013 | 0.006 | 0.018 |
| Tₕ: One way Hash | 0.009 | 0.004 | 0.006 |
| Tᵣ: Random Number Generation | 2.011 | 0.118 | 1.185 |
| T [symbol] : Symmetric Key Operations | 0.017 | 0.08 | 0.013 |

[symbol]

indicates data missing or illegible when filed

TABLE 3

| | Mobile | Content | Smart | |
|---|---|---|---|---|
| Reference | User | Server | Device | RT(ms) |
| Wazid et | 19T [symbol] + 6T [symbol] + | 11 [symbol] + 6T [symbol] + | 12T [symbol] + 5T [symbol] + | 60.425 |
| al. [13] | T [symbol] + T [symbol] | T [symbol] + T [symbol] | T [symbol] + T [symbol] | |
| Hussain et | 8T [symbol] + 2T [symbol] + | 7T [symbol] + T [symbol] | 6T [symbol] + 4T [symbol] + | 32.929 |
| al. [42] | 2T [symbol] | | T [symbol] | |
| Jia. et | 5T [symbol] + 2T [symbol] + | 9T [symbol] + 3T [symbol] + | 4T [symbol] + 2T [symbol] + | [symbol] |
| al. [43] | T [symbol] + T [symbol] | T [symbol] + T [symbol] | T [symbol] + T [symbol] | |
| Chang et | 6T [symbol] + 2T [symbol] + | 6T [symbol] + 2T [symbol] + | 8T [symbol] | 14.339 |
| al. [37] | T [symbol] | T [symbol] | | |
| Challa et | 11T [symbol] + T [symbol] + | 5T [symbol] | 6T [symbol] + T [symbol] + | 12.574 |
| al. [44] | T [symbol] | | T [symbol] | |
| Proposed | 19T [symbol] + 6T [symbol] + | 9T [symbol] + 5T [symbol] + | 12T [symbol] + 5T [symbol] + | 59.651 |
| | T [symbol] + T [symbol] | T [symbol] + 2T [symbol] + T [symbol] | T [symbol] + T [symbol] | |

[symbol]

indicates data missing or illegible when filed

### B. Communication Cost

In the present disclosure, the communication cost of the proposed method is calculated and compared with the existing methods. Table 4 shows the sizes of different metric entities used in the proposed technique. For comparison and simplicity, the size of a user ID is 64 bits, the timestamp is 32 bits, the hash function is 160 bits, the random number is 64 bits, encryption (AES) is 128 bits, the size of ECC operation is fixed at 320 bits to maintain a comparable security level with 1024-bit RSA. Table 5 shows a detailed comparison among the suggested methods with regard to the bits transferred. However, the proposed method provides better security than all the above mentioned methods.

Security analysis according to the present disclosure will be described as follows.

To describe the security of the proposed scheme, the scheme was scrutinized through formal and informal security analyses below.

### A. Authentication Proof Based on the Burrows-Abadi-Needham Logic (Ban Logic)

The security of the proposed method is formally analyzed in the standard model using the widely accepted Burrows-Abadi-Needham logic.

As assumptions for BAN logic, Table 6 shows some of the logical postulates of BAN logic and the meaning related to the postulates.

In setting security goals, Table 7 shows established security goals and logical notations of BAN logic.

$${G}_{1} : {U}_{x} \vert ≡ SD \vert ≡ Ux {⟷}^{{SK}_{x , y}} SD$$

The idealized form of the proposed scheme will be described as follows.

$$M 1 : SD \to {U}_{x} : ( h ( {r}_{z} ‖ {T}_{3} ) ⊕ h ( {T}_{1} ‖ {T}_{2} ‖ {T}_{3} ‖ {d}_{z} ‖ {Q}_{x} ) ) , \\ h ( {RD}_{z} ‖ {TC}_{z} ) ⊕ h ( h ( {r}_{z} ‖ {T}_{3} ) ‖ {T}_{1} ) , Mz . P , Mz + h$$

$$( SKz , x ‖ {T}_{1} ‖ {T}_{3} ) . dz , h ( {ID}_{y} ‖ h ( {r}_{y} ‖ {T}_{z} ‖ RDy ‖ {T}_{3} ) , {T}_{3} ) , \\ {TID}_{x}^{new} ⊕ h ( h ( {r}_{x} , {T}_{1} ) ‖ {RD}_{TA} ‖ {T}_{4} ) , h ( {TID}_{x}^{new} ‖ {T}_{4} ‖ {TID}_{x} ) , ( {T}_{3} , t 4 )$$

Table 4 shows the sizes of different metric entities used in the proposed technique.

TABLE 4

| Attribute | Cost Value | |
|---|---|---|
| Identity | 64 | bits |
| Timestamp | 32 | btis |
| Hash Function (SHA-1) | 160 | btis |
| Random Number | 64 | btis |
| Encryption (AES) | 128 | btis |
| Elliptic Curve (ECC) | 320 | btis |

Table 5 shows communication cost analysis.

TABLE 5

| | | | Content | | Smart | |
|---|---|---|---|---|---|---|
| | User | | Server | | Device | Total |
| Reference | (Uₓ) | | (CS_{y}) | | (SDₓ) | Cost |
| Proposed | 800 | bits | 928 + 352 | bits | 992 bits | 3072 bits |
| Wazid et | 1056 | bits | 1088 | bits | 928 bits | 3072 bits |
| al. [13] | | | | | | |
| Hussain et | 896 | bits | 672 | bits | 512 bits | 2080 bits |
| al. [42] | | | | | | |
| Jia. et | 672 | bits | 1344 + 832 | bits | 672 bits | 3520 bits |
| al. [43] | | | | | | |
| Chang et | 672 | bits | 608 + 352 | bits | 512 bits | 2144 bits |
| al. [37] | | | | | | |
| Challa et | 672 | bits | 352 | bits | 512 bits | 1536 bits |
| al. [44] | | | | | | |

Table 6 shows some of the logical postulates of BAN logic and the meaning related to the postulates.

TABLE 6

| | |
|---|---|
| $\frac{\text{?}}{\text{?}}$ | Message-caning rule |
| $\frac{\text{?}}{\text{?}}$ | Nonce-verification rule |
| $\frac{\text{?}}{\text{?}}$ | Belief Rule |
| $\frac{\text{?}}{\text{?}}$ | Fresh conjuncatenation rule |
| $\frac{\text{?}}{\text{?}}$ | Jurisdiction rule |

$\text{?} \text{indicates text missing or illegible when filed}$

Table 7 shows established security goals and logical notations of BAN logic.

TABLE 7

| | |
|---|---|
| A\| ≡ B | A believes a statement B |
| $A {↔}^{K} Y$ | Share a key K between A and Y |
| #B | B is fresh |
| A B | A sees B |
| A\| ~ B | A said B |
| (B,C)_{K} | B,C is hashed by key K |
| {B}_{K} | B is hashed with key K |
| <B>_{K} | B is encrypted with key K |

Assuming the following,

$$A 1 : {U}_{x} \vert ≡ {}^{′} \# ( {r}_{x} , T 1 )$$

$$A 2 : {U}_{x} \vert ≡ SD \vert ≡ SD ∼ X$$

$$A 3 : {U}_{x} \vert ≡ SD ⇒ ( SD {⟷}^{{SK}_{l} x} SD )$$

$$A 4 : SD \vert ≡ CS ⇒ CS \vert ∼ X$$

$$A 5 : CS \vert ≡ ( {r}_{y} , {T}_{4} , {T}_{2} )$$

$$A 6 : SD \vert ≡ \# ( {r}_{z} , {T}_{3} )$$

$$A 7 : {U}_{x} \vert ≡ ( {U}_{x} {⟷}^{{RD}_{x}} CS )$$

$$A 8 : SD \vert ≡ ( CS {⟷}^{{RD}_{z}} SD )$$

$$A 9 : SD \vert ≡ ( CS {⟷}^{dz} SD )$$

$$A 10 : {U}_{x} \vert ≡ ( {U}_{x} {⟷}^{{RD}_{TA}} CS )$$

$$A 11 : {U}_{x} \vert ≡ ( {U}_{x} {⟷}^{{TID}_{x}} CS )$$

$$A 12 : {U}_{x} \vert ≡ ( {U}_{x} {⟷}^{{TID}_{x}} SD )$$

$$A 13 : {U}_{x} \vert ≡ CS \vert ⇒ CS \vert ∼ X$$

$$A 14 : SD \vert ≡ ( SD {⟷}^{{RD}_{TA}} {M}_{z} )$$

Step 1—According to Message 1:

$$P 1 : {U}_{x} {〈 {U}_{x} {⟷}^{{Q}_{x}} SD , {T}_{1} , {T}_{3} , {d}_{z} 〉}_{〈 rz 〉} , \\ {〈 {U}_{x} {⟷}^{{RD}_{z}} SD , {TC}_{z} , {T}_{1} , {T}_{3} 〉}_{〈 rz 〉} , 〈 {M}_{z} . P 〉 , {〈 {M}_{z} , {T}_{1} , {T}_{3} 〉}_{〈 {U}_{x} {⟷}^{{SK}_{zx}} SD , {d}_{z} 〉} ,$$

$$〈 {ID}_{y} , {U}_{x} {⟷}^{{RD}_{y}} SD , {T}_{2} , {T}_{3} 〉 〈 ry 〉 , 〈 {T}_{3} 〉 , \\ 〈 {U}_{x} {⟷}^{{RD}_{x}} CS , {TID}_{x} , {T}_{1} , {T}_{4} 〉 {U}_{x} {⟷}^{{r}_{x}} SD , {〈 {U}_{x} {⟷}^{{TID}_{x}} CS , {T}_{3} , {T}_{4} 〉}_{〈 {TID}_{x}^{new} 〉}$$

Step 2—According to P1, Assumptions 1, 2, 3, and message meaning rule, the following are obtained.

$$P 2 : {U}_{x} {〈 {T}_{1} , {T}_{2} , {d}_{z} 〉}_{〈 rz 〉} , {〈 {T}_{1} , {T}_{3} , {TC}_{z} 〉}_{〈 rz 〉} , 〈 Mz . P 〉 , \\ {〈 {M}_{z} , {T}_{2} , {T}_{3} 〉}_{〈 dz 〉} , {〈 {ID}_{y} , {T}_{1} , {T}_{3} 〉}_{〈 ry 〉} , 〈 {T}_{3} 〉 , {〈 {T}_{1} , {T}_{4} 〉}_{〈 {TID}_{x}^{new}}$$

Step 3—According to P2 and message belief rule, nonce verification and freshness rule, the following are obtained.

$$P 3 : {U}_{x} \vert ≡ CS \vert ≡ {〈 dz 〉}_{〈 rz 〉} , {〈 {TC}_{z} 〉}_{〈 rz 〉} , 〈 Mz . P 〉 , {〈 Mz 〉}_{〈 dz 〉} , {〈 {ID}_{y} 〉}_{〈 ry 〉}$$

Step 4—According to S3, Assumptions A2 and A13, and jurisdiction rule, the following are obtained.

$$P 4 : {U}_{x} \vert ≡ {〈 dz 〉}_{〈 rz 〉} , {〈 TCz 〉}_{〈 rz 〉} , 〈 Mz . P 〉 , {〈 Mz 〉}_{〈 dz 〉} , {〈 {ID}_{y} 〉}_{〈 ry 〉}$$

Step 5—According to P4 and P3, Assumptions A2, A13, A14, and belief rule, the following are obtained.

$$P 5 : {U}_{x} \vert ≡ SD \vert ≡ Ux {⟷}^{{SK}_{x , y}} SD Goal 1$$

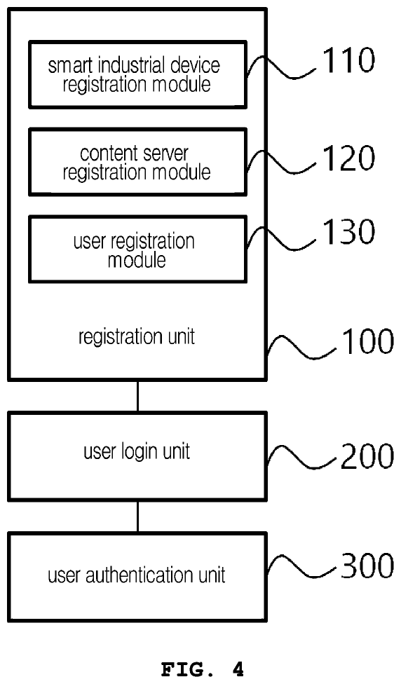

FIG. 4 is a diagram illustrating a system for advanced user authenticated key management for 6G-based industrial applications according to an embodiment of the present disclosure.

As shown in FIG. 4, the system includes: a registration unit 100 for performing registration of smart industrial device, content server, and user by using a trusted authority and an ID thereof; a user login unit 200 for computing whether a Hamming distance between a biometric secret key provided to the registration unit and a currently recognized biometric secret key is equal to or less than a pre-defined error tolerance threshold; and a user authentication unit 300 for performing mutual authentication among a pre-registered user Ux, a content server CSy, and an accessed smart industrial device SDz.

The registration unit performs registration by selecting a private key dTA of the trusted authority with a collision-resistant one-way cryptographic hash function h(⋅).

In addition, the registration unit includes: a smart industrial device registration module 110 configured to select a unique ID and a random secret key for a smart device, compute a pseudo ID of the smart device, a public key of the random secret key, and a temporary credential according to a registration timestamp, and transmit a result of computation to the content server for registration; a content server registration module 120 configured to select a unique ID and a secret key to compute a pseudo ID of the content server, and compute and store a public key and a pseudo random number in a secure/tamper-resistant database to register the content server; and a user registration module 130 configured to select a user unique ID, a password, and a long-term random password to compute a masked password through a secure channel, and compute a pseudo ID and generate a temporary ID to compute and transmit a secret key for the user and a temporary credential to a user mobile device to perform user registration.

The user login unit 200 is configured to compute whether the Hamming distance between the biometric secret key and the currently recognized biometric secret key is equal to or less than the pre-defined error tolerance threshold, and imprint the biometric secret key at a sensor of a user mobile device, and select an accessed smart device with a pseudo ID RDz, and transmit a login message to the content server via an open channel.

The user authentication unit 300 receives a message from a user mobile device and perform authentication by the content server when a set condition is true. The content server transmits a message Msg2={RDz, M4, MM2, M5, M6, T1, T2} to the smart industrial device SDz via an open channel, and according to a set condition of message reception time, the content server is authenticated by the smart industrial device. The smart industrial device computes and transmits a session key and a signature to a user mobile Ux via an open channel. When messages are received from the smart industrial device and the content server and a session key and a set condition are satisfied, authentication is performed.

The present disclosure described above is not limited by the above-described embodiment and the accompanying drawings, and those skilled in the art will appreciate that various substitutions, modifications, and changes are possible without departing from the technical spirit of the present disclosure.

What is claimed is:

1. A system for advanced user authentication key management for 6G-based industrial applications, the system comprising:
a registration unit configured to perform registration of smart industrial device, content server, and user by using a trusted authority and an ID of the trusted authority;
a user login unit configured to compute whether a Hamming distance between a biometric secret key provided to the registration unit and a currently recognized biometric secret key is equal to or less than a pre-defined error tolerance threshold; and
a user authentication unit configured to perform mutual authentication among a pre-registered user Ux, a content server CSy, and an accessed smart industrial device SDz.

2. The system of claim 1, wherein the registration unit is configured to perform registration by selecting a private key dTA of the trusted authority with a collision-resistant one-way cryptographic hash function h(⋅).

3. The system of claim 1, wherein the registration unit comprises:
a smart industrial device registration module configured to select a unique ID and a random secret key for a smart device, compute a pseudo ID of the smart device, a public key of the random secret key, and a temporary credential according to a registration timestamp, and transmit a result of computation to the content server for registration;
a content server registration module configured to select a unique ID and a secret key to compute a pseudo ID of the content server, and compute and store a public key and a pseudo random number in a secure/tamper-resistant database to register the content server; and
a user registration module configured to select a user unique ID, a password, and a long-term random password to compute a masked password through a secure channel, and compute a pseudo ID and generate a temporary ID to compute and transmit a secret key for the user and a temporary credential to a user mobile device to perform user registration.

4. The system of claim 1, wherein the user login unit is configured to
compute whether the Hamming distance between the biometric secret key and the currently recognized biometric secret key is equal to or less than the pre-defined error tolerance threshold, and imprint the biometric secret key at a sensor of a user mobile device, and select an accessed smart device with a pseudo ID RDz, and transmit a login message to the content server via an open channel.

5. The system of claim 1, wherein the user authentication unit is configured to receive a message from a user mobile device and perform authentication by the content server when a set condition is true,
the content server is configured to transmit a message to the smart industrial device (SDz) via an open channel, and according to a set condition of message reception time, the content server is authenticated by the smart industrial device,
the smart industrial device is configured to compute and transmit a session key and a signature to a user mobile Ux via an open channel, and
when messages are received from the smart industrial device and the content server and a session key and a set condition are satisfied, authentication is performed.
